(19) United States
(12) Patent Application Publication
(10) Pub. No.: US 2026/0138546 A1
(43) Pub. Date: May 21, 2026

(54) IN-VEHICLE APPARATUS AND METHOD OF OPERATING IN-VEHICLE APPARATUS

(71) Applicant: TOYOTA JIDOSHA KABUSHIKI KAISHA, Toyota-shi (JP)

(72) Inventors: Kenichiro SUGIHARA, Kounosu-shi (JP); Xunan QIAN, Koto-ku (JP)

(73) Assignee: TOYOTA JIDOSHA KABUSHIKI KAISHA, Toyota-shi (JP)

(21) Appl. No.: 19/370,492

(22) Filed: Oct. 27, 2025

(30) Foreign Application Priority Data
Nov. 21, 2024 (JP) 2024-203513

(51) Int. Cl. B60R 16/033

(52) U.S. Cl. CPC B60R 16/033

(57) ABSTRACT

An in-vehicle apparatus mounted in a vehicle includes a controller that generates information to cause a battery in the vehicle to supply power to a system for monitoring the inside of the vehicle when a predetermined condition is met for a change in position of the vehicle from a start to a stop of an engine of the vehicle and/or a time.

### CROSS-REFERENCE TO RELATED APPLICATION

This application claims priority to Japanese Patent Application No. 2024-203513, filed on Nov. 21, 2024, the entire contents of which are incorporated herein by reference.

### TECHNICAL FIELD

The present disclosure relates to an in-vehicle apparatus and a method of operating the in-vehicle apparatus.

### BACKGROUND

By imaging vehicles in motion or parked, technology for addressing not only accidents during driving but also incidents and the like around the vehicles has been proposed. Additionally, Patent Literature (PTL) 1 discloses an example of systems that monitor the interior of vehicles to prevent children or the like from being left or trapped inside.

### CITATION LIST

### Patent Literature

PTL 1: JP 7370073 B2

### SUMMARY

Monitoring systems for parked vehicles operate by receiving power from batteries mounted in the vehicles with engines stopped, and it is required to reduce exhaustion of the batteries. Therefore, there is room to improve the efficiency of power supply to the monitoring systems.

Hereinafter, an in-vehicle apparatus and the like that enable improved efficiency of power supply in a monitoring system for a vehicle will be disclosed.

An in-vehicle apparatus according to the present disclosure is an in-vehicle apparatus mounted in a vehicle, the in-vehicle apparatus including a controller configured to generate information to cause a battery in the vehicle to supply power to a system for monitoring the inside of the vehicle when a predetermined condition is met for a change in position of the vehicle from a start to a stop of an engine of the vehicle and/or a time.

A method of operating an in-vehicle apparatus according to another aspect of the present disclosure is a method of operating an in-vehicle apparatus mounted in a vehicle, the method including generating information to cause a battery in the vehicle to supply power to a system for monitoring the inside of the vehicle when a predetermined condition is met for a change in position of the vehicle from a start to a stop of an engine of the vehicle and/or a time.

The in-vehicle apparatus and the like according to the present disclosure enable improved efficiency of power supply in a monitoring system for a vehicle.

### BRIEF DESCRIPTION OF THE DRAWINGS

In the accompanying drawings:

FIG. 1 is a diagram illustrating an example configuration of an information provision system;

FIG. 2 is a diagram illustrating an example configuration of an in-vehicle apparatus;

FIG. 3 is a flowchart illustrating an example operation procedure of the in-vehicle apparatus; and

FIG. 4 is a flowchart illustrating an example operation procedure of the in-vehicle apparatus.

### DETAILED DESCRIPTION

An embodiment will be described below with reference to the drawings.

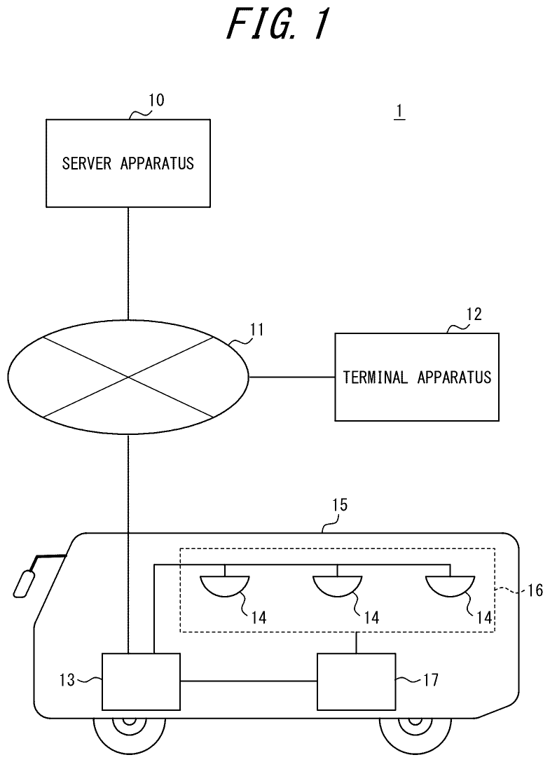

FIG. 1 is a diagram illustrating an example configuration of an information provision system according to the embodiment. An information provision system 1 includes at least one server apparatus 10, at least one terminal apparatus 12, and at least one in-vehicle apparatus 13 mounted in a vehicle 15, which are communicably connected to each other via a network 11. The server apparatus 10 is, for example, a server computer that belongs to a cloud computing system or another computing system, and functions as a server that implements various functions. The terminal apparatus 12 is an information processing terminal that exchanges various information with the server apparatus 10, and is, for example, a personal computer, a tablet terminal apparatus, or the like. The vehicle 15 is a bus vehicle that transport passengers such as infants and children, and is an internal combustion engine vehicle, a Hybrid Electric Vehicle (HEV), a Plug-in Hybrid Electric Vehicle (PHEV), or the like, which is configured to enable a battery of a battery apparatus 17 to be charged while an engine is running. The in-vehicle apparatus 13 is a computer that has a communication function and an information processing function. The in-vehicle apparatus 13 is communicably connected to a monitoring system 16 for the interior of the vehicle 15 and the battery apparatus 17, and controls operations of the monitoring system 16 and the battery apparatus 17. The monitoring system 16 has one or more cameras 14 provided in such positions as to image the interior of the vehicle 15, and a control circuit thereof. The monitoring system 16 operates by receiving power supply from the battery apparatus 17. The battery apparatus 17 includes a battery such as a lithium-ion battery that can supply power to various mechanisms of the vehicle 15 and the monitoring system 16, and a control circuit that controls the charging and discharging of the battery. The network 11 may include, for example, a mobile communication network, the Internet, an ad hoc network, a local area network (LAN), a metropolitan area network (MAN), other networks, or any combination thereof.

The information provision system 1 supports the provision of information to a supervisor, guardians, or the like in order to prevent passengers from being left, trapped, or the like in the vehicle 15. When the vehicle 15 ends transportation of the passengers and parks at a predetermined parking location (hereinafter referred to as wait location), the monitoring system 16 captures images of the interior of the vehicle 15 using the cameras 14 under the control of the in-vehicle apparatus 13. The in-vehicle apparatus 13 acquires the captured images from the cameras 14, and transmits the captured images to the server apparatus 10 via the network 11. The server apparatus 10 transmits the captured images to the terminal apparatus 12 of a monitoring staff of a monitoring center, the supervisor or guardians of the infants and children, or the like. This enables the monitoring staff or the like to grasp the status of the interior of the vehicle 15 and detect a likelihood of a passenger being left or trapped inside. In the parked vehicle 15, the monitoring system 16 operates by receiving power supply from the battery apparatus 17. Since the engine of the vehicle 15 is likely to be stopped at this time, excessive exhaustion of the battery may cause a risk of battery failure. In the present embodiment, the in-vehicle apparatus 13 controls the power supply from the battery apparatus 17 to be efficient, thereby reducing the risk of battery failure.

The in-vehicle apparatus 13 according to the present embodiment is mounted in the vehicle 15 used for transporting passengers. The in-vehicle apparatus 13 generates information to cause a battery in the vehicle 15 to supply power to the monitoring system 16 for monitoring the inside of the vehicle 15 after the engine is stopped, when a predetermined condition (hereinafter referred to as power supply condition) is met for a change in position of the vehicle 15 from a start to a stop of the engine of the vehicle 15 and/or a time. Here, the power supply condition is a condition that indicates a certain degree or more of likelihood of the vehicle 15 having ended transportation and parked at the wait location, which will be described in detail later. Since the monitoring system 16 is operated by power supply from the in-vehicle battery or a built-in battery of the in-vehicle apparatus 13 when the power supply condition is met, unnecessary operations of the monitoring system 16 can be prevented in a situation in which it is unnecessary to operate the monitoring system 16, such as during temporary stopping or parking of the vehicle 15 at locations other than the wait location, thus preventing unnecessary exhaustion of the battery. This allows improved efficiency of power supply in the monitoring system 16 for the vehicle 15.

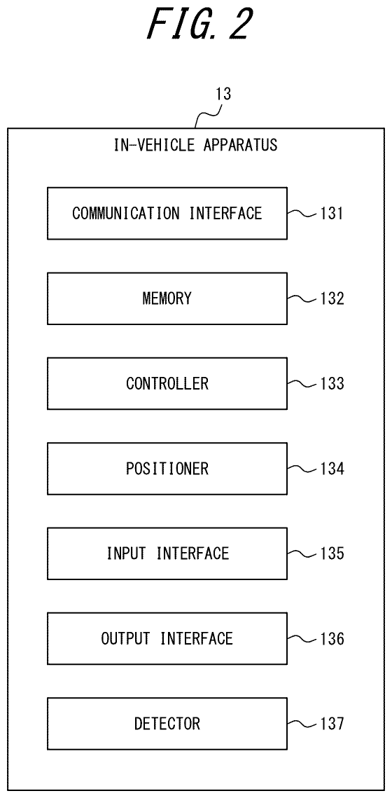

FIG. 2 illustrates an example configuration of the in-vehicle apparatus 13. The in-vehicle apparatus 13 includes a communication interface 131, a memory 132, a controller 133, a positioner 134, an input interface 135, an output interface 136, and a detector 137. These components may be configured as a single control apparatus, as two or more control apparatuses, or with another apparatus such as a control apparatus and a communication device. The control apparatus includes, for example, an electronic control unit (ECU) or the like. The communication device includes, for example, a data communication module (DCM) or the like. The components are communicably connected to each other or to equipment in the vehicle 15, by an in-vehicle network compliant with a standard such as a controller area network (CAN). The in-vehicle apparatus 13 may be configured to include, in part, a device equivalent to the terminal apparatus 12. The in-vehicle apparatus 13 operates by receiving power supply from the built-in battery or the battery apparatus 17.

The communication interface 131 has a module compliant with a mobile communication standard such as Long Term Evolution (LTE), 4th Generation (4G), or 5th Generation (5G), or a module compliant with in-vehicle LAN such as CAN. The in-vehicle apparatus 13 performs, via the communication interface 131, information communication with other apparatuses via the network 11 connected through a nearby router apparatus or a mobile communication base station, and information communication with the monitoring system 16 and the battery apparatus 17 via the in-vehicle LAN.

The memory 132 includes one or more semiconductor memories, one or more magnetic memories, one or more optical memories, or a combination of at least two of these types. The semiconductor memories are, for example, random access memory (RAM) or read only memory (ROM). The RAM is, for example, static RAM (SRAM) or dynamic RAM (DRAM). The ROM is, for example, electrically erasable programmable ROM (EEPROM). The memory 132 functions as, for example, a main memory, an auxiliary memory, or a cache memory. The memory 132 stores information to be used for operations of the controller 133 and information obtained by operations of the controller 133.

The controller 133 includes one or more processors, one or more dedicated circuits, or a combination thereof. The processors are general purpose processors, such as central processing units (CPUs), or dedicated processors, such as graphics processing units (GPUs), specialized for particular processing. The dedicated circuits are, for example, field-programmable gate arrays (FPGAs), application specific integrated circuits (ASICs), or the like. The controller 133 executes information processing related to operations of the in-vehicle apparatus 13 while controlling components of the in-vehicle apparatus 13.

The functions of the controller 133 are realized by execution of a control/processing program by a processor included in the controller 133. The control/processing program is a program for causing a computer to execute processing of steps included in operations of the controller 133, thereby enabling the computer to realize the functions corresponding to the processing of the steps. That is, the control/processing program is a program for causing a computer to function as the controller 133. Some or all of the functions of the controller 133 may be realized by a dedicated circuit included in the controller 133.

The positioner 134 includes one or more global navigation satellite system (GNSS) receivers. The GNSS includes, for example, global positioning system (GPS), quasi-zenith satellite system (QZSS), BeiDou, global navigation satellite system (GLONASS), and/or Galileo. The positioner 134 transmits a positioning result to the controller 133, and the controller 133 calculates positional information on the in-vehicle apparatus 13.

The input interface 135 includes one or more interfaces for input. The interfaces for input include, for example, a microphone that accepts audio input, physical keys, capacitive keys, a pointing device, a touch screen integrally provided with a display, or the like. The input interface 135 accepts operations for inputting information to be used for operations of the controller 133 and transmits the input information to the controller 133.

The output interface 136 includes one or more interfaces for output. The interfaces for output include, for example, a speaker or a display. The display is, for example, a liquid crystal display (LCD) or an organic electro-luminescence (EL) display. The output interface 136 outputs information to be obtained by operations of the controller 133.

The detector 137 has one or more interfaces with one or more sensors that detect the states of various parts of the vehicle 15, or has the one or more sensors. The sensors include sensors that detect the on/off state of accessory power of the vehicle 15, the start/stop of the engine, and the like, a vehicle speed sensor, and the like. The detector 137 transmits various information obtained from the sensors to the controller 133.

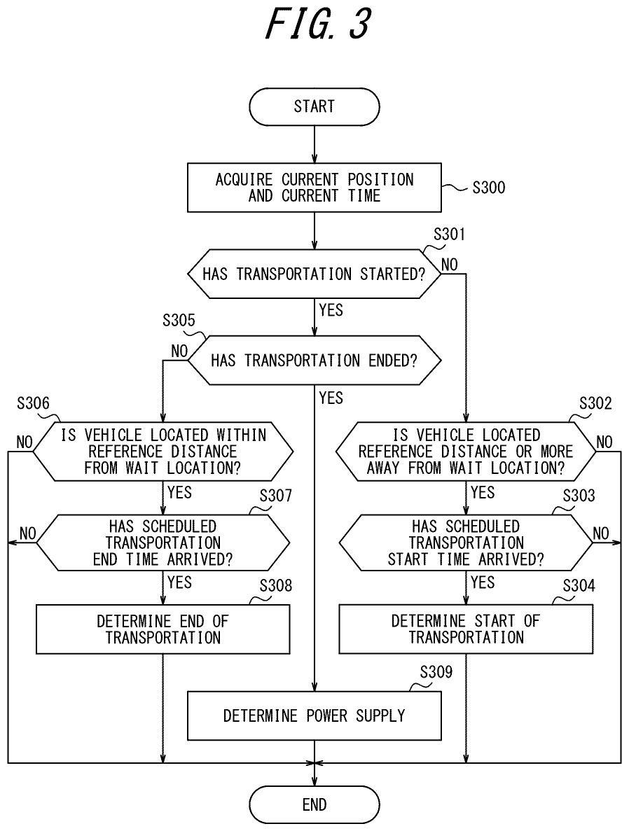

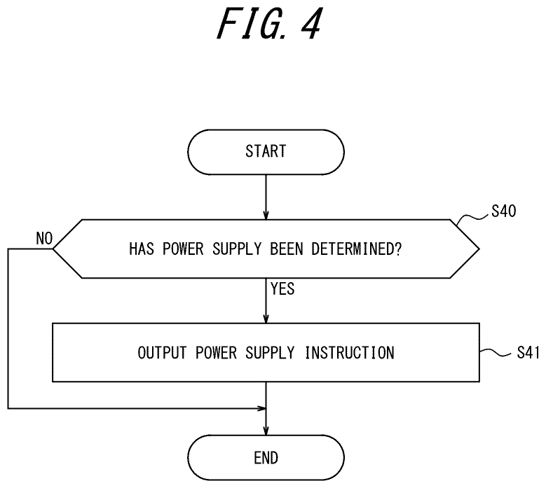

FIGS. 3 and 4 are flowcharts illustrating operating procedures of the in-vehicle apparatus 13 according to the present embodiment. Each step in FIGS. 3 and 4 is a step of information processing executed by the controller 133.

The procedure in FIG. 3 is executed at any cycle, for example, every few tens of microseconds to several seconds, when the accessory power of the vehicle 15 is turned on and the controller 133 detects a start of the engine.

In S300, the controller 133 acquires the current position of the vehicle 15 and the current time. The controller 133 acquires the current position from the positioner 134. The controller 133 also acquires the current time from, for example, a clock function of a processor.

In S301, the controller 133 determines whether transportation has started. The controller 133 determines whether transportation has started in the subsequent steps based on conditions. However, when the controller 133 has already determined that the transportation has started since the procedure in FIG. 3 has begun, the operation proceeds to step S305 (Yes), and when the controller 133 has not yet determined that the transportation has started, the operation proceeds to step S302 (No).

In S302, the controller 133 determines whether the vehicle 15 is located a reference distance or more away from a wait location. The controller 133 compares, using the current position and map information, the distance from the wait location to the current position on a map with any reference distance. The reference distance is any distance indicating that the vehicle 15 is estimated to be traveling, for example, several tens of meters to several hundred meters. When the controller 133 determines that the vehicle 15 is located the reference distance or more away (Yes), the operation proceeds to step S303. When the controller 133 determines that the vehicle 15 is not located the reference distance or more away (No), one processing cycle of FIG. 3 ends.

In S303, the controller 133 determines whether a scheduled transportation start time has arrived. The scheduled transportation start time is stored in advance in the memory 132. When the controller 133 determines that the current time has arrived at the scheduled transportation start time (Yes), the operation proceeds to step . When the controller 133 determines that the current time has not arrived at the scheduled transportation start time (No), one processing cycle of FIG. 3 ends.

In S304, the controller 133 determines a start of transportation. The determination result is stored in the memory 132. Then, the controller 133 ends one processing cycle of FIG. 3.

When it is determined in S301 that transportation has started, the controller 133 determines in step S305 whether the transportation has ended. The controller 133 determines an end of the transportation in the subsequent steps. However, when the controller 133 has already determined an end of the transportation since the procedure in FIG. 3 has begun, the operation proceeds to step S309 (Yes). When the controller 133 has not yet determined that an end of the transportation, in other words, it is after the transportation is started and still ongoing, the controller 133 determines that the transportation has not ended yet, and the operation proceeds to step S306 (No).

In S306, the controller 133 determines whether the vehicle 15 is located within a reference distance from a wait location. The controller 133 compares, using the current position and map information, the distance from the wait location to the current position on a map with any reference distance. The reference distance is any distance indicating that the vehicle 15 is estimated to be returned, for example, several tens of meters to several hundred meters. This reference distance may be the same value as the reference distance used in step S302 or a different value. When the controller 133 determines that the vehicle 15 gets near the wait location to the reference distance or less (Yes), the operation proceeds to step S307. When the controller 133 determines that the vehicle 15 does not get near the wait location to the reference distance or less (No), one processing cycle of FIG. 3 ends. Note that, the wait location used for determination in step S306 may be the same location as the wait location used for determination in step S302 or a different location.

In S307, the controller 133 determines whether a scheduled transportation end time has arrived. The scheduled transportation end time is stored in advance in the memory 132. When the controller 133 determines that the current time has arrived at the scheduled transportation end time (Yes), the operation proceeds to step S308. When the controller 133 determines that the current time has not arrived at the scheduled transportation end time (No), one processing cycle of FIG. 3 ends.

In S308, the controller 133 determines an end of the transportation. The determination result is stored in the memory 132. Then, the controller 133 ends one processing cycle of FIG. 3.

When it is determined in S305 that the transportation has ended, a power supply condition is met. The power supply condition is that transportation has started and that the transportation has ended. A condition for determining that transportation has started is met when the vehicle 15 is located the reference distance or more away from the wait location and the scheduled transportation start time has arrived. A condition for determining that the transportation has ended is met when, after the condition for determining that the transportation has started is met, the vehicle 15 has returned to within the reference distance from the wait location and the scheduled transportation end time has arrived. In a variation, the condition for determining that transportation has started may be met when the vehicle 15 is located the reference distance or more away from the wait location or when the scheduled transportation start time has arrived. The condition for determining that the transportation has ended may be met when, after the condition for determining that the transportation has started is met, the vehicle 15 has returned to within the reference distance from the wait location or when the scheduled transportation end time has arrived. Furthermore, the condition for determining that transportation has started according to the present embodiment and the condition for determining that the transportation has ended according to the variation may be combined, or the condition for determining that transportation has started according to the variation and the condition for determining that the transportation has ended according to the present embodiment may be combined.

In S309, the controller 133 determines power supply from the battery apparatus 17 to the monitoring system 16. The determination result is stored in the memory 132. Then, the controller 133 ends one processing cycle of FIG. 3.

By periodically executing the procedure of FIG. 3, the condition for determining that transportation has started and the condition for determining that the transportation has ended are sequentially met, according to travel of the vehicle 15 and the passage of time.

The procedure of FIG. 4 is executed by the controller 133 when the controller 133 detects that the engine of the vehicle 15 has been stopped and the accessory power has been cut off.

In S40, the controller 133 determines whether power supply from the battery apparatus 17 to the monitoring system 16 has been determined. When the power supply has already been determined (Yes), the operation proceeds to step S41, and the controller 133 outputs a power supply instruction to the battery apparatus 17. Upon receiving the power supply instruction, the battery apparatus 17 starts discharging to the monitoring system 16. On the other hand, when the power supply has not been determined (No), the controller 133 ends the procedure of FIG. 4.

In a variation, the controller 133 may execute control to supply power from the built-in battery of the in-vehicle apparatus 13 to the monitoring system 16, instead of or in addition to transmitting the power supply instruction to the battery apparatus 17.

According to the above procedure, when the power supply condition is met, the monitoring system 16 is operated with power supply from the in-vehicle battery or the built-in battery of the in-vehicle apparatus 13, thus preventing unnecessary exhaustion of the battery. This allows improved efficiency of power supply in the monitoring system 16 for the vehicle 15.

In a variation, the controller 133 changes the scheduled transportation start time in step S303 and the scheduled transportation end time in step S307, taking into account information on a transportation schedule. The transportation schedule is information specifying the date and time when transportation is to be carried out, including information on day of the week, time zone, long holidays, and the like. The information on the transportation schedule is stored in advance in the memory 132. The information on the transportation schedule may be set in the in-vehicle apparatus 13 by a user inputting that information to the in-vehicle apparatus 13 directly or via the server apparatus 10 using the terminal apparatus 12. For example, the controller 133 determines the presence or absence of a transportation schedule for the day, with reference to the information on the transportation schedule. When there is a transportation schedule, the controller 133 determines a scheduled transportation start time and a scheduled transportation end time for that day. According to such a variation, it is possible to determine the power supply condition more precisely, thus enabling more reliable control of power supply in the monitoring system 16 for the vehicle 15.

While the embodiment has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

1. An in-vehicle apparatus mounted in a vehicle, the in-vehicle apparatus comprising a controller configured to cause a battery in the vehicle to supply power to a system for monitoring an inside of the vehicle, by outputting information to cause the battery to supply power to the system when a predetermined condition is met for a change in position of the vehicle from a start to a stop of an engine of the vehicle and/or a time.

2. An in-vehicle apparatus mounted in a vehicle, the in-vehicle apparatus comprising a controller configured to generate information to cause a battery in the vehicle to supply power to a system for monitoring an inside of the vehicle when a predetermined condition is met for a change in position of the vehicle from a start to a stop of an engine of the vehicle and/or a time.

3. The in-vehicle apparatus according to claim 2, wherein the predetermined condition includes that the vehicle is located a predetermined distance or more away from a first location when the engine has been started, and/or that a scheduled transportation start time for passengers has arrived.

4. The in-vehicle apparatus according to claim 2, wherein the predetermined condition further includes that the vehicle is located less than a reference distance from a second location when the engine has been stopped, and/or that a scheduled transportation end time for passengers has arrived.

5. The in-vehicle apparatus according to claim 1, wherein the controller is configured to determine the condition for the time taking into account a transportation schedule for passengers.

6. The in-vehicle apparatus according to claim 5, wherein the controller is configured to set the transportation schedule based on input information.

7. The in-vehicle apparatus according to claim 1, wherein the battery includes a built-in battery of the in-vehicle apparatus.

8. A method of operating an in-vehicle apparatus mounted in a vehicle, the method comprising generating information to cause a battery in the vehicle to supply power to a system for monitoring an inside of the vehicle when a predetermined condition is met for a change in position of the vehicle from a start to a stop of an engine of the vehicle and/or a time.

9. The method according to claim 8, wherein the predetermined condition includes that the vehicle is located a predetermined distance or more away from a first location when the engine has been started, and/or that a scheduled transportation start time for passengers has arrived.

10. The method according to claim 9, wherein the predetermined condition further includes that the vehicle is located less than a reference distance from a second location when the engine has been stopped, and/or that a scheduled transportation end time for passengers has arrived.

11. The method according to claim 8, wherein the condition for the time is determined taking into account a transportation schedule for passengers.

12. The method according to claim 11, wherein the transportation schedule is set based on input information.

13. The method according to claim 8, wherein the battery includes a built-in battery of the in-vehicle apparatus.
